(19) United States
(12) Patent Application Publication
(10) Pub. No.: US 2015/0072059 A1
(43) Pub. Date: Mar. 12, 2015

(54) SPLIT DECANTER

(71) Applicants: Michael J. Zaczek, Redondo Beach, CA (US); James C. McDade, Arlington, VA (US)

(72) Inventors: Michael J. Zaczek, Redondo Beach, CA (US); James C. McDade, Arlington, VA (US)

(21) Appl. No.: 14/478,449

(22) Filed: Sep. 5, 2014

Related U.S. Application Data
(60) Provisional application No. 61/874,672, filed on Sep. 6, 2013.

(51) Int. Cl. B01F 3/04; A23L 2/02; B01F 5/06; C12G 1/00

(52) U.S. Cl. CPC B01F 3/04787; C12G 1/00; A23L 2/02; B01F 5/0641; A23V 2002/00; B01F 2215/0072
USPC 426/474; 261/7

(57) ABSTRACT

There is disclosed a device to decant liquids, such as red wine, that comprises a top section having a pouring neck, removably coupled to a bottom section. In one embodiment, the top section is coupled with a threaded screw and a food grade seal there between. In various embodiments, the top and bottom sections may comprise an inorganic material, such as a glass or metal, and an organic material, such as a polycarbonate, polypropylene or polyethylene. Combinations of these materials may also be used. Methods of decanting wine using the disclosed device such as at a desired temperature are also disclosed. These methods comprises thermally treating the bottom section prior to assembly and decanting occurs.

This application claims the benefit of domestic priority to U.S. Provisional Application No. 61/874,672, filed on Sep. 6, 2013, and which is herein incorporated by reference in its entirety.

The present disclosure relates to a device used to decant spirits and fruit-based drinks, such as wine, before consumption. More particularly, the disclosed device is directed to a decanter that has a top portion that is removably affixed to a bottom portion. There is also disclosed a method of cleaning the decanter described herein, the method comprising separating a top portion from a bottom portion, such as by unscrewing both portions.

As wine enthusiasts know, some wines, including unfiltered wines or red wines that contain tannins or undergo ageing, benefit from a separation and/or oxygenation operation called “decantation.” The primary purpose of decantation is to aerate the wine or “let it breathe.” To do so, a wine (or other spirit), is typically poured through a device that introduces air into the wine, or into a larger device to allow the wine to be exposed to the air, and thus be oxygenated.

The efficacy of the aeration process is generally directly proportional with the area of the “exchange surface” of the vessel used for decantation. The “exchange surface” of the vessel is defined as the free surface which will come into contact with the decanted wine to be oxygenated. To allow the entire wine volume to undergo the desirable oxygenation process, the exchange surface of the decanter is preferably much larger than the surface offered inside the bottle in which it has been stored.

To achieve acceptable aeration, decanters generally have a shape comprising a pouring neck connected to a bottom receptacle with very large base. Prior to the present disclosure, decanters typically were comprised of a one piece device that made access to the bottom portion difficult. In addition, to avoid any interaction between the wine and the exchange surface, decanters are generally made of an inert and typically fragile material, such as glass or crystal, which can be readily fashioned into a one-piece device by blow molding, for example.

Moreover, from an aesthetic point of view, glass or crystal decanters allow the consumer to enjoy the presentation of the aerated wine. However, traditional decanters have inherent drawbacks associated with their shape. One such drawback is related to their ability to be cleaned. Their unique shape, while providing a certain utility for aeration, also prohibits easy cleaning of all internal surfaces. As a result, there are a variety of products on the market used to clean decanters. Non-limiting examples of products used to clean decanters include flexible brushes and sponges that can match the curves of the decanter, and stainless steel beads, which scrub the internal surfaces of the decanter.

Even if these products are effective, they do not address another drawback of current decanters, namely their inability to be rapidly dried after cleaning. Often in a commercial setting, such as a bar or restaurant, there is a need for rapid turnaround time between uses of a decanter and the use of wet or spotted decanters is undesirable.

As a result, the present disclosure is directed to a unique decanter design that solves the foregoing problems. In particular, the inventive design allows for the decanter to be broken apart allowing for easy cleaning and rapid drying of the interior surfaces. In one embodiment, there is described a decanter comprising two or more sections, integrally and removably connected with a leak-proof seal, such as an air-tight and/or water-tight seal.

Non-limiting examples of the types of seals that can be used include a silicone material, or other food-grade polymers, co-polymers, terpolymers, that can be used as an o-ring. Non-limiting examples of such materials include elastomer materials that are compliant with the requirements of the Food and Drug Administration (FDA), United States Pharmacopeia (USP), 3-A Sanitary Standards (3-A) or EC Regulation 1935/2004.

Aside from the subject matter discussed above, the present disclosure includes a number of other exemplary features such as those explained hereinafter. It is to be understood that both the foregoing description and the following description are exemplary only

The accompanying figures are incorporated in, and constitute a part of this specification.

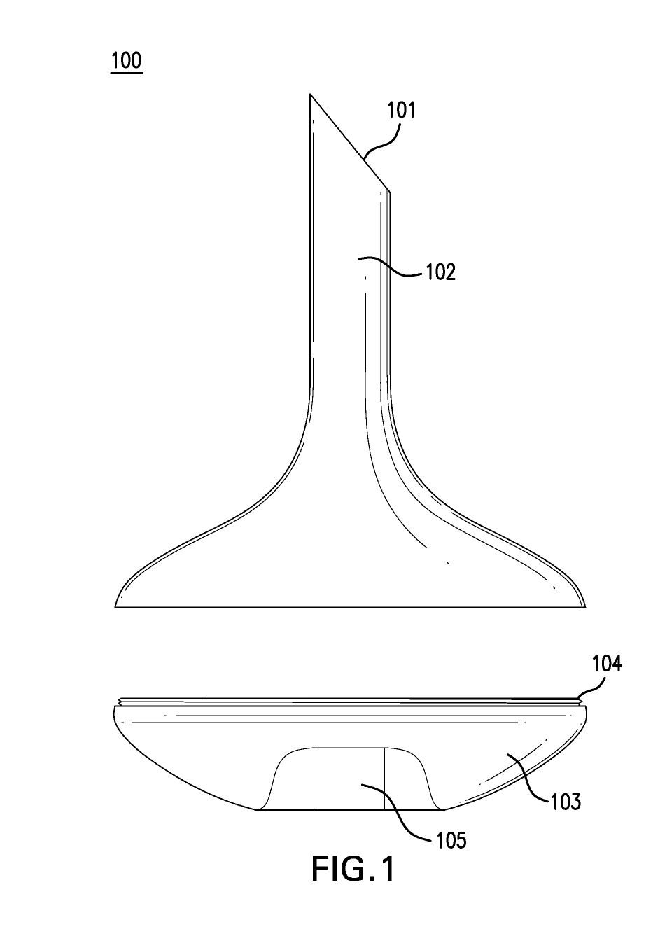

FIG. 1 is a side view of a decanter according to the present invention, showing the top and bottom portions separated.

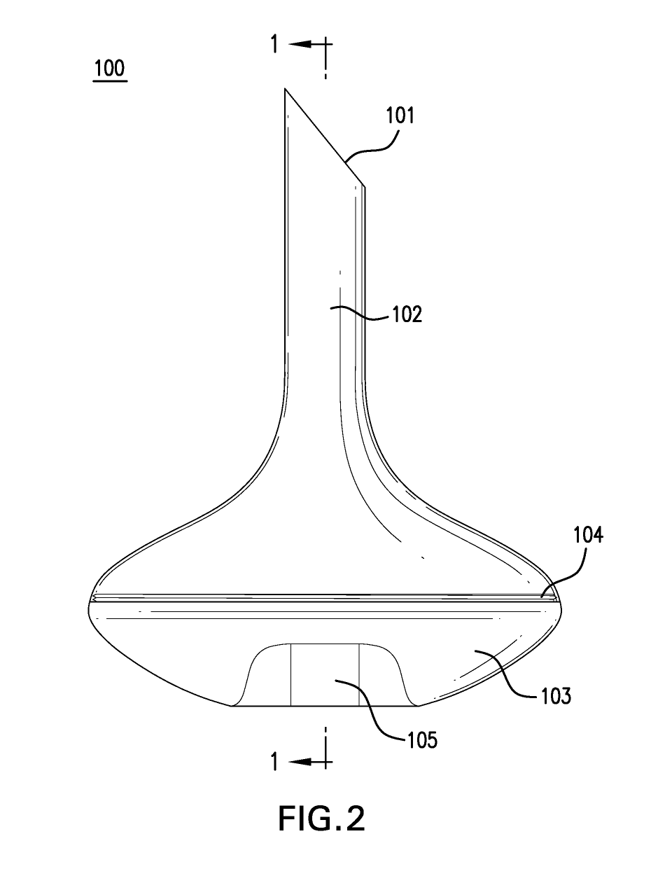

FIG. 2 is a side view of a decanter according to the present invention, showing the top and bottom portions integrally connected.

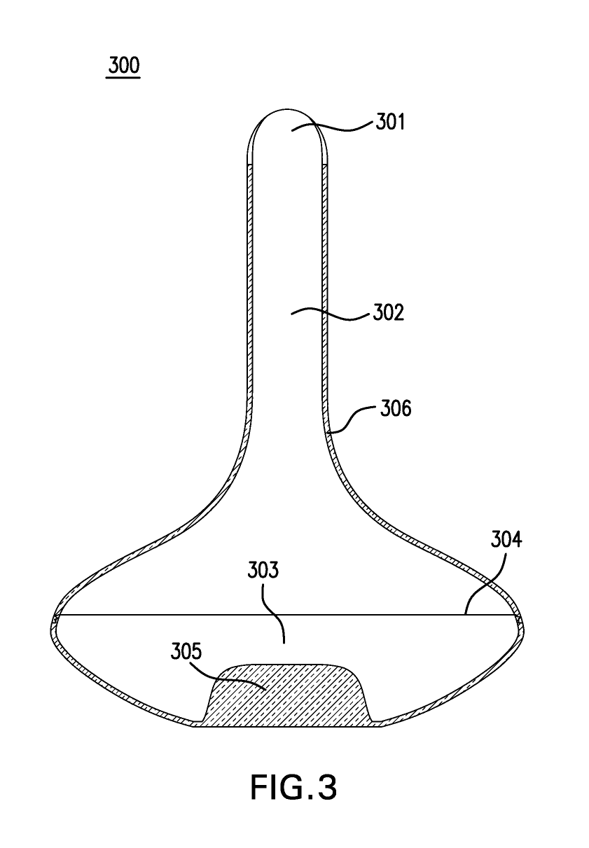

FIG. 3 is a side view of another embodiment of a decanter according to the present invention.

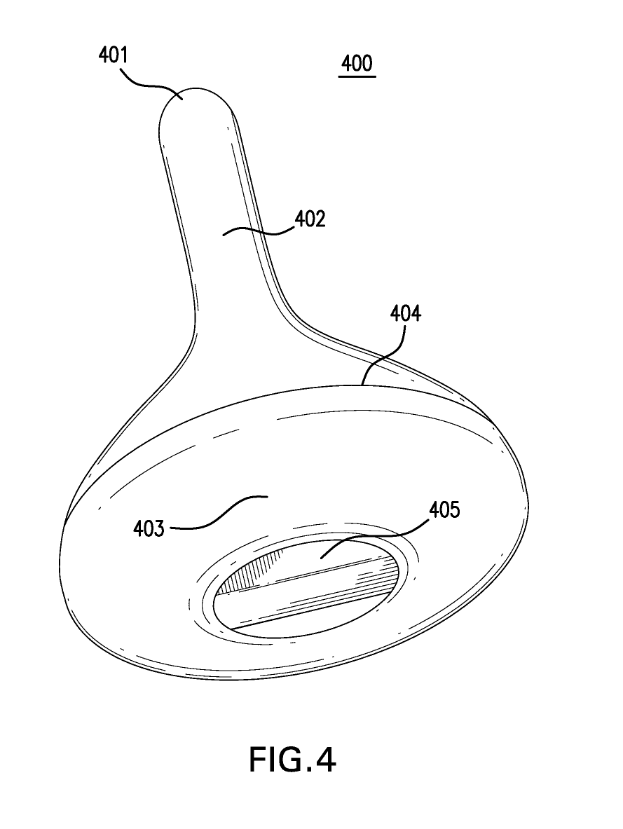

FIG. 4 is a bottom view of the decanter shown in FIG. 3.

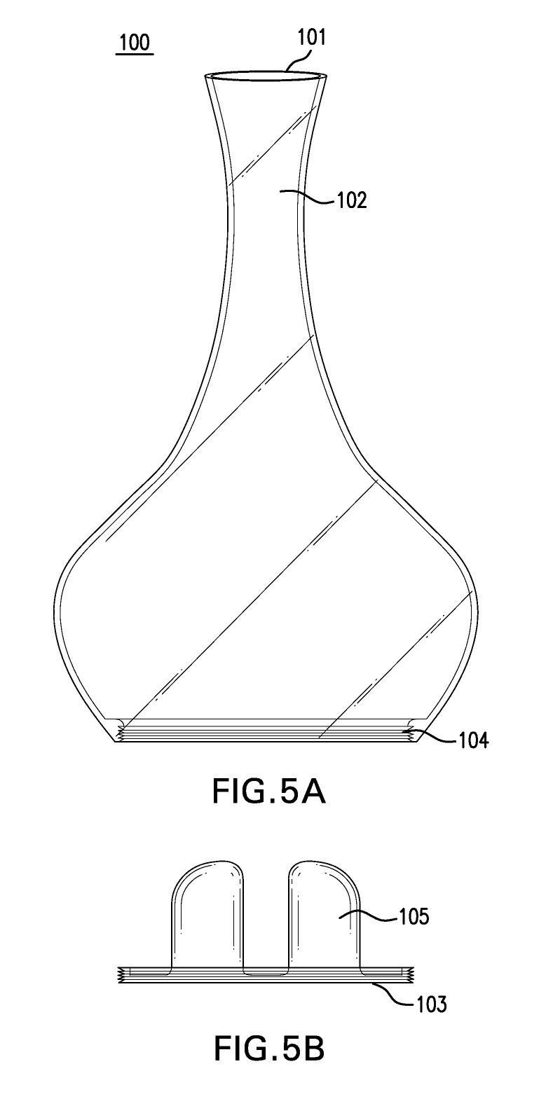

FIGS. 5A and 5B are side views of a decanter according to the present invention, showing a top portion open at the bottom (FIG. 5A), and the removable flat bottom portion (FIG. 5B) separated from the top portion.

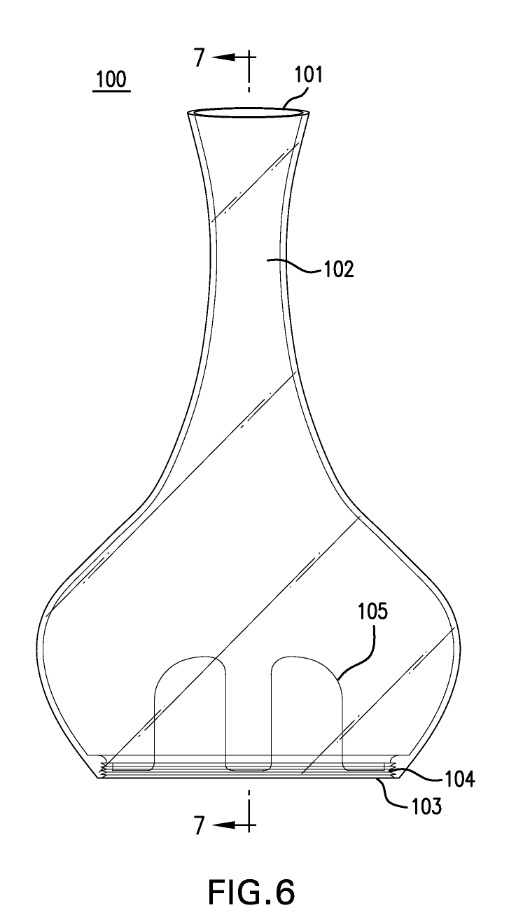

FIG. 6 is a side view of the decanter of FIG. 5, with the bottom portion screwed into the top portion.

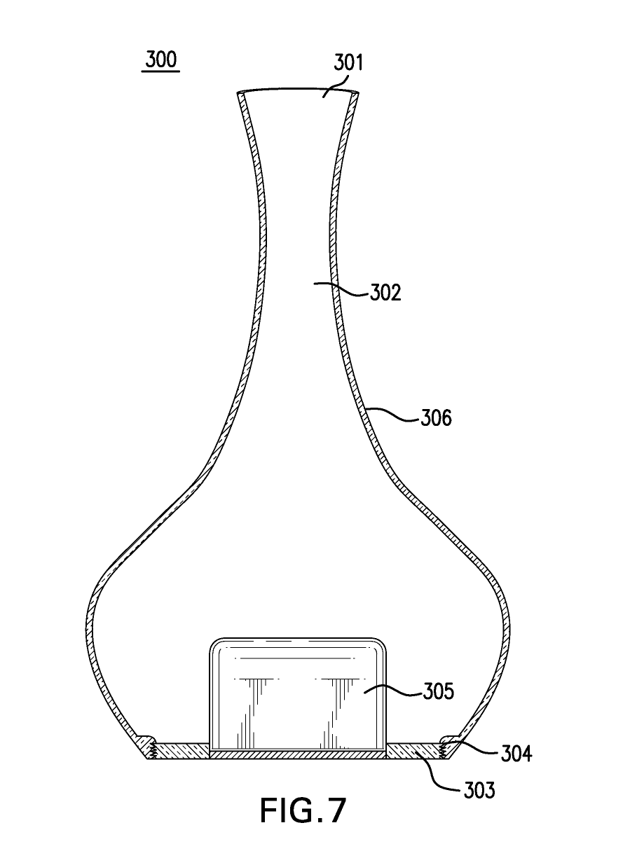

FIG. 7 is a side view of a decanter according to an embodiment, with the bottom portion screwed into the top portion.

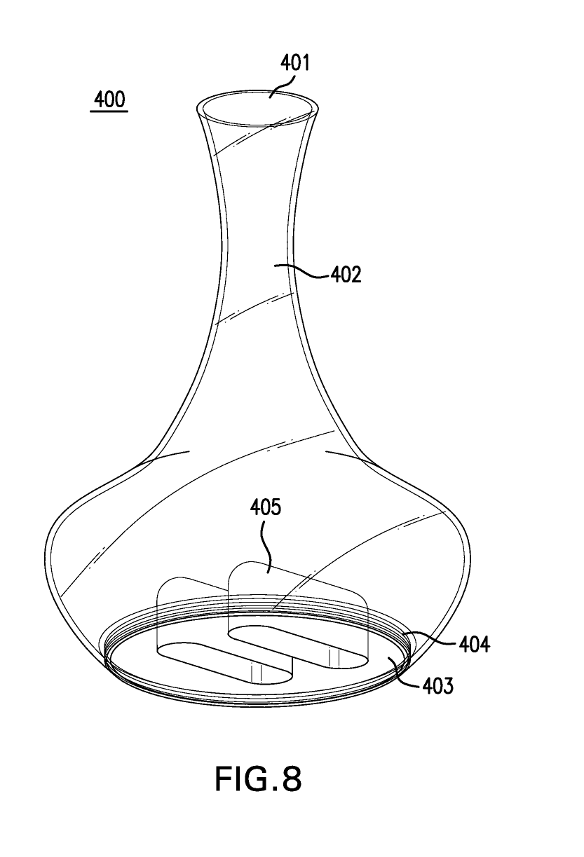

FIG. 8 is a side/bottom view of a decanter according to an embodiment, with the bottom portion screwed into the top portion.

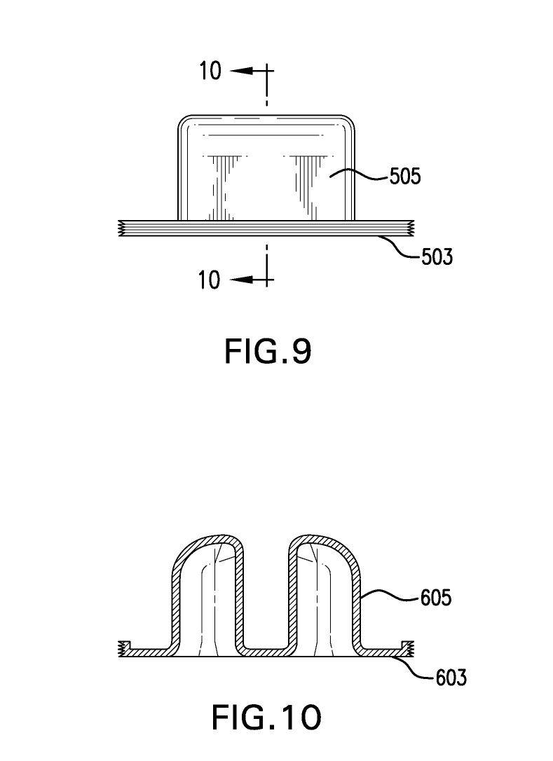

FIG. 9 is a side view of a removable flat bottom portion according to an embodiment.

FIG. 10 is a side view of a removable flat bottom portion according to an embodiment.

There is disclosed a device to decant liquids, such as wines, comprising a top section having a pouring neck for introducing liquids into the device, and for removing decanted liquids from the device, and a bottom section removably coupled to the top section, such as by a threaded screw. In one embodiment, there is an air-tight and/or water-tight seal between the top section and said bottom section. In one embodiment, the seal comprises a food grade material chosen from a silicone, polymeric, co-polymeric, or terpolymeric material

In the device according to the present disclosure, the diameter of the pouring neck is smaller than the diameter of the bottom section.

FIG. 1 is a disassembled view of the device 100 for aerating wine comprising a top section 102 and a bottom section 103. This Figure shows that the top and bottom sections can be connected with a threaded screw 104, which may or may not include an air-tight or water-tight seal there-between.

FIG. 1 further shows a top section having an opening for introducing the liquid to be decanted 102, further comprising an elongated pouring neck. In addition, FIG. 1 shows the bottom portion having a handle 105 that assists in the removal of the top and bottom sections, such as providing a gripping mechanism. An addition view of this gripping mechanism is provided in FIG. 4 at 405.

FIG. 2 shows an assembled view of the device of FIG. 1. It is apparent from all the Figures that in various embodiments, there is provided an increased surface area or exchange surface, below the elongated pouring neck. This free surface will come into contact with the decanted wine to be oxygenated, and will serve as the reservoir for holding the wine, and allow the entire wine volume to undergo the desirable oxygenation process.

In a non-limiting embodiment of the device, either one of the top section or the bottom section or both sections, is made from an inert, inorganic material. Examples of inert, inorganic materials that could be used include glass or metal, such as stainless steel.

In an alternative embodiment of the device, either one of the top section or the bottom section or both sections, is made from an organic material, such as a food-grade, shatter-proof material. Examples of organic materials that could be used include a polycarbonate, polypropylene or polyethylene.

In another embodiment, the bottom portion of the decanter simply comprises the flat base of the decanter. Therefore, in this embodiment, the bottom section comprises a flat base that is integrally connected to the remainder of the decanter, such as through a threaded connection. This embodiment is exemplified in FIGS. 5A, 5B, 6-8. Unlike the embodiments shown in FIGS. 1-4, the embodiments shown in FIGS. 5A, 5B, and 6-8 comprises a removable flat base (shown in FIGS. 9 and 10), which may be more easily unscrewed than a larger bottom section. In addition, these embodiments allow for the threaded section of the top section (see for example, FIG. 5A at 104 and FIG. 7 at 304) to have a larger thickness than a section closer to the top of the decanter, thus increasing the strength and integrity of the decanter at the point of connection between the top and bottom sections. The difference between the wall thickness of the top portion of the decanter is best shown in FIG. 7, by comparing the wall thickness of the top portion 306 to the wall thickness of the removable bottom section 304.

In the embodiments shown in FIGS. 5A, 5B, and 6-8, the bottom section (e.g., FIG. 5B at 105) comprises a threaded portion 103 that will screw into the threaded portion 104 of the top section (FIG. 5A). Embodiments showing these sections connected are provided in FIGS. 6 and 7, the difference being the configuration of the bottom section. For example, FIG. 6 shows a bottom section 105 having a protrusion that allows the hand to more easily grip and screw the bottom section on and off the top section of the decanter, which is different than the bottom section shown in FIG. 7. See also, FIGS. 9 and 10 which show these removable bottom sections alone.

There is also disclosed a method of decanting liquids, such as wine or spirits, that takes advantage of the unique capabilities associated with split device. For example, the split device allows the separate sections to be heated or chilled prior to assembly and decanting. As a result, the bottom portion that comprises the reservoir, may be heated or more typically cooled to a temperature desirable for the decanted liquid.

It is known that certain wines are preferably chilled and served at a temperature lower than room temperature, which is assumed to be 72° F. By having the ability to chill the individual components of the inventive decanter, it is possible to decant wine at or near the same temperature the wine is served. Therefore, in one embodiment, there is disclosed a method of chilling the bottom section of the decanter to a desired temperature range, prior to assembly of the decanter, and decanting of the wine.

The following are non-limiting examples of optimum temperature ranges for different types of wines, with the desired temperature ranging from 39-65° F. In one embodiment, the bottom section of the disclosed decanter can be chilled to within any one of these ranges prior to decanting the particular wine of choice.
Sparkling Wine and Rose: 39-46° F.;
Light Red Wines: 48-52° F.;
Classic Red Wines: 43-62° F.;
Crisp, Dry White Wine: 43-46° F.;
Complex Red Wines: 61-63° F.;
Full-Bodied, Mature Red Wines: 61-61° F.;
Classic White Wine: 48-52° F.;
Port: 50-64° F.; and
Complex White Wine: 50-54° F.

As stated, a method of decanting wine according to the present disclosure may first comprise cooling the bottom section of the inventive decanter to within a desired temperature range, such as by placing it in a wine cooler, or refrigerator. When the bottom section comprises a material having high thermal transfer properties, such as a metal, particularly stainless steel, silver or copper, the bottom section can be quickly cooled prior to decanting. This allows rapid cleaning, cooling and re-use of the bottom section, which is beneficial for a high volume establishment, such as a bar or restaurant. Because only the bottom section of the inventive device needs to be cooled, it also avoids the problems associated with space needed to cool an entire decanter, or the potential of breaking the pouring neck characteristic of the top section of a decanter.

In one embodiment, there is disclosed a method of decanting a wine or spirit that comprises thermally treating the bottom section of the device to achieve a desired temperature; connecting the top section and the thermally treated bottom section of the device; pouring the liquid to be decanted into the top section ; and allowing it to collect in the thermally treated bottom section.

Other embodiments of the device include a top section comprising a glass and a bottom section comprising a polycarbonate. The inverse embodiment is also possible, e.g., a top section comprising a polycarbonate and a bottom section comprising a glass. The previously disclosed method of independently thermally treating the top and bottom sections of the decanter is also possible with these various materials.

As used herein, the terms “a”, “an”, and “the” are intended to encompass the plural as well as the singular. In other words, for ease of reference only, the terms “a” or “an” or “the” may be used herein, such as “a surface”, “an integrally connected seal”, “the decanter”, etc., but are intended, unless explicitly indicated to the contrary, to mean “at least one,” such as “at least one surface”, “at least one integrally connected seal”, “the at least one decanter”, etc. This is true even if the term “at least one” is used in one instance, and “a” or “an” or “the” is used in another instance, e.g. in the same paragraph or section. Furthermore, as used herein, the phrase “at least one” means one or more, and thus includes individual components as well as mixtures/combinations.

The term “comprising” (and its grammatical variations) as used herein is used in the inclusive sense of “having” or “including,” with which it may be used interchangeably. These terms are not to be construed as being used in the exclusive sense of “consisting only of” unless explicitly so stated.

Other than where expressly indicated, all numbers expressing quantities of ingredients and/or reaction conditions are to be understood as being modified in all instances by the term “about.” This includes terms such as “all” or “none” and variants thereof. As used herein, the modifier “about” means within the limits that one of skill in the art would expect with regard to the particular quantity defined; this may be, for example, in various embodiments, ±10% of the indicated number, ±5% of the indicated number, ±2% of the indicated number, ±1% of the indicated number, ±0.5% of the indicated number, or ±0.1% of the indicated number.

Additionally, where ranges are given, it is understood that the endpoints of the range define additional embodiments, and that sub-ranges including those not expressly recited are also intended to include additional embodiments.

As used herein, “formed from,” “generated by,” and variations thereof, mean obtained from chemical reaction of, wherein “chemical reaction,” includes spontaneous chemical reactions and induced chemical reactions. As used herein, the phrases “formed from” and “made by” (or versions thereof) are open ended and do not limit the components of the composition to those listed.

The compositions and methods according to the present disclosure can comprise, consist of, or consist essentially of the elements and limitations described herein, as well as any additional or optional ingredients, components, or limitations described herein or otherwise known in the art.

It should be understood that, unless explicitly stated otherwise, the steps of various methods described herein may be performed in any order, and not all steps must be performed, yet the methods are still intended to be within the scope of the disclosure.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A device to decant spirits and fruit-based drinks, said device comprising :
a top section having a pouring neck for introducing liquids into the device, and for removing decanted liquids from the device, and
a bottom section removably coupled to the top section.

2. The device of claim 1, wherein the diameter of the pouring neck is smaller than the diameter of the bottom section.

3. The device of claim 1, wherein said top section and said bottom section are coupled by a threaded screw.

4. The device of claim 1, further comprising an air-tight and/or water-tight seal between said top section and said bottom section.

5. The device of claim 4, wherein said seal comprises a food grade material chosen from a silicone, polymeric, co-polymeric, or terpolymeric material.

6. The device of claim 1, wherein at least one of said top section or said bottom section of said device is made from an inert, inorganic material.

7. The device of claim 6, wherein said inert, inorganic material comprises glass.

8. The device of claim 1, wherein at least one of said top section or said bottom section of said device is made from an organic material.

9. The device of claim 1, wherein said organic material is a polycarbonate material.

10. The device of claim 1, wherein said top section comprises glass and said bottom section comprises a polycarbonate, or said top section comprises a polycarbonate and said bottom section comprises glass.

11. The device of claim 1, wherein said bottom section has a flat base.

12. The device of claim 11, wherein said bottom section further comprises at least one protrusion or handle for assisting in the removal of said top and bottom sections.

13. The device of claim 1, wherein said bottom section comprises a metal chosen from stainless steel, silver or copper.

14. A method of decanting a beverage chosen from spirits and fruit-based drinks using a split decanter, said method comprising:
providing a decanter having a top section that is separate from a bottom section;
assemblying the top section and the bottom section;
pouring the beverage into said top section; and
collecting the beverage in said bottom section.

15. The method of claim 14, wherein said bottom section comprises a metal, and said method further comprises cooling the bottom section to a desired temperature below room temperature prior to assemblying.

16. The method of claim 15, wherein said metal comprises stainless steel, silver or copper.

17. The method of claim 15, wherein said desired temperature ranges from 39-65° F.

18. The method of claim 15, wherein said assemblying comprising screwing the top section and the bottom section together.

19. The method of claim 15, wherein said beverage is wine.
